(19) United States
(12) Patent Application Publication
(10) Pub. No.: US 2024/0406683 A1
(43) Pub. Date: Dec. 5, 2024

(54) BROADCAST INFORMATION RELIABILITY THROUGH ROLLING WINDOW REPETITION

(71) Applicant: Aclara Technologies LLC, St. Louis, MO (US)

(72) Inventor: Christopher Keith Fleck, St. Louis, MO (US)

(21) Appl. No.: 18/679,089

(22) Filed: May 30, 2024

Related U.S. Application Data
(60) Provisional application No. 63/470,014, filed on May 31, 2023.

(51) Int. Cl. H04W 4/06; H04W 72/30

(52) U.S. Cl. CPC H04W 4/06; H04W 72/30

(57) ABSTRACT

Systems and methods for operating a wireless network using rolling window repetition. One example wireless base station includes an electronic processor and a transceiver coupled to the electronic processor. The electronic processor is configured to, for each of a plurality of sets of information, determine a relevancy period. The electronic processor is configured to, for a first broadcast time, generate a broadcast packet that includes sets of information selected from the plurality of sets of information based on the relevancy periods. The electronic processor is configured to transmit, via the transceiver, the broadcast packet.

### CROSS-REFERENCE TO RELATED APPLICATIONS

The present application is related to and claims benefit under 35 U.S.C. § 119(e) from U.S. Provisional Patent Application Ser. No. 63/470,014, filed May 31, 2023, entitled “Broadcast Information Reliability Through Rolling Window Repetition,” the entire contents of which is incorporated herein by reference.

### BACKGROUND OF THE INVENTION

Utilities, for example, electric utilities, use wireless data communication networks to connect smart devices for monitoring and controlling their infrastructure. For example, electric usage meters, sensors, and other devices may provide telemetry data to automated billing and monitoring systems for an electric utility. Increasingly, such communications are two-way, for example, when used for controlling smart electric grids using distributed automation. Such wireless communication networks may include hundreds of base stations communicating with thousands of end nodes using limited radiofrequency spectrum.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates a communications system in accordance with some embodiments.

FIG. 2 is a diagram of a wireless base station of the system of FIG. 1 in accordance with some embodiments.

FIG. 3 is a flowchart illustrating a method for improving broadcast information reliability in wireless communication networks through the use of rolling window repetition in accordance with some embodiments.

FIG. 4 is a diagram illustrating aspects of the operation of the system of FIG. 1 in accordance with some embodiments.

FIG. 5 is a diagram illustrating aspects of the operation of the system of FIG. 1 in accordance with some embodiments.

FIG. 6 is a diagram illustrating aspects of the operation of the system of FIG. 1 in accordance with some embodiments.

FIG. 7 is a diagram illustrating aspects of the operation of the system of FIG. 1 in accordance with some embodiments.

FIG. 8 is a table illustrating an example of packet efficiency and reliability achieved using an application of the method of FIG. 3 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

In some instances, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

As noted, electric utilities may deploy short packet wireless communication networks including hundreds of low power base stations communicating with thousands of end nodes using limited radiofrequency spectrum. Compared to wireline networks, packet reliability when transmitting over wireless networks may be lower due to RF impediments not present in wireline systems. However, it may be impractical or too costly to deploy wireline networks in some environments.

Techniques have been developed to help mitigate these impediments and improve the overall packet reliability in wireless networks. Many of these techniques add additional signaling between the sender and receiver of the packet to help ensure successful packet delivery. However, these techniques are only tractable when the wireless network has spare capacity to accommodate the overhead generated by the additional signaling. For example, with broadcast signaling, where there is a single sender and many receivers (e.g., sometimes tens of thousands), transmitting one packet may require thousands of acknowledgements. In such cases, the overhead required to improve overall packet reliability would limit the capacity of the network, rendering the network impractical for its intended purpose (i.e., providing reliable data communication for thousands of nodes). To address the overhead problem, some broadcast techniques simply repeat a packet multiple times in an attempt to increase the reliability without incurring feedback overhead. However, these techniques merely shift the additional network overhead from the return path (original receiver to original sender) to the original/primary path (original sender to original receiver).

In wireless networks where broadcast control signaling is needed from a coordinating device to many managed devices, spectrum use may be asymmetric. For example, the amount of spectrum required for or allocated to the downlink (e.g., from coordinating device to managed devices) may be much less than the amount of spectrum required for or allocated to the uplink. This is caused by the asymmetry in the number of devices requiring use of the spectrum. Given this structure, additional signaling overhead on a much smaller downlink path can negatively affect the network similarly to the thousands of acknowledgements that would have to be spread over more uplink spectrum. Form this normalized view, the additional signaling overhead is not attractive in either case and an alternative is desired. Therefore, systems and methods are needed to improve packet reliability in wireless networks without introducing excessive overhead.

To address these problems and for other reasons, systems and methods are provided herein for improving broadcast information reliability in wireless communication networks through the use of rolling window repetition. Among other things, embodiments described herein provide for a lower “cost” means, in terms of spectrum, of providing redundancy in the downlink path by spreading the information of various downlink packets across one another. Using such embodiments, the downlink packet count does not increase, only the packet size. In addition, the packet overhead to information ratio is reduced by including more useful information, making each packet more information efficient.

Such embodiments provide increased broadcast packet efficiency and information content reliability for wireless communications networks. By identifying relevancy periods for the information content and including in the packets information content that is relevant now and in the near future, greater reliability is achieved without adding signal overhead. In addition, embodiments repeat information content that is still relevant one packet to the next while removing information content that is no longer relevant. Using such embodiments, reliability is increased while overhead is limited, resulting in increased network throughput. This, in turn, leads to a more spectrally efficient and effective use of the network and its computing resources.

One example embodiment provides a wireless base station. The wireless base station includes an electronic processor and a transceiver coupled to the electronic processor. The electronic processor is configured to, for each of a plurality of sets of information, determine a relevancy period. The electronic processor is configured to, for a first broadcast time, generate a broadcast packet that includes sets of information selected from the plurality of sets of information based on the relevancy periods. The electronic processor is configured to transmit, via the transceiver, the broadcast packet.

Another example embodiment provides a method for operating a wireless base station. The method includes determining, with an electronic processor, a relevancy period for each set of information of a plurality of sets of information. The method includes, for a first broadcast time, generating a broadcast packet that includes sets of information selected from the plurality of sets of information based on the relevancy periods. The method includes transmitting, via a transceiver, the broadcast packet.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

It should be understood that although certain figures presented herein illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

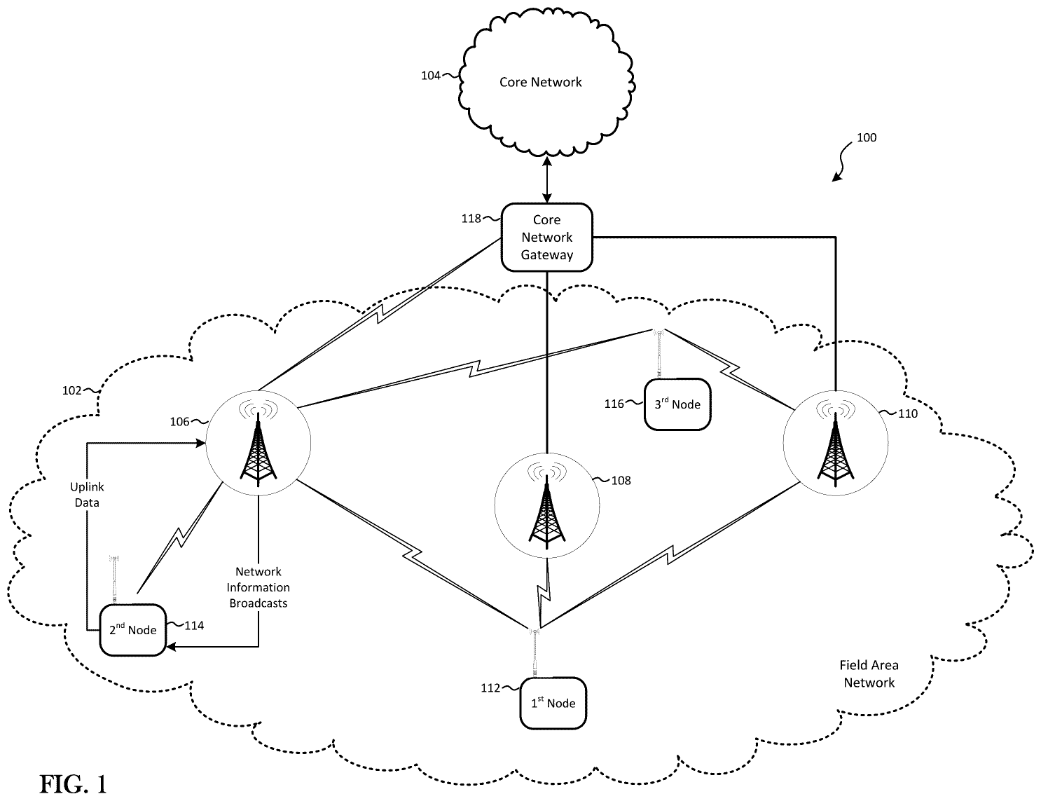

FIG. 1 is a diagram of one example embodiment of a communication system 100. In the example illustrated, the system 100 includes a field area network 102 and a core network 104. In the illustrated example, the field area network 102 is a radio area network including a first base station 106, a second base station 108, a third base station 110, a first end node 112, a second end node 114, and a third end node 116. In one example, the field area network 102 is low power short packet wireless communication network deployed to monitor and control equipment on an electric utility grid and the core network 104 is a back end computing network for the electric utility (including, for example, billing systems, grid monitoring systems, and other command and control for the electric grid). The first end node 112, the second end node 114, and the third end node 116 each include appropriate hardware and software components (e.g., electronic processors, memories, transceivers) for operating the end nodes as described herein.

In the example illustrated, the field area network 102 is communicatively coupled to the core network 104 by a core network gateway 118. For example, each of the first base station 106, the second base station 108, and the third base station 110 are coupled to the core network gateway 118 via a suitable wired or wireless backhaul connection. The core network gateway 118 includes hardware and software components (e.g., electronic processors, memories, transceivers) for controlling electronic communications between the field area network 102 and the core network 104. In some embodiments, the core network 104 may be a cloud computing platform accessible via one or more networks, including over the Internet using encrypted tunnels or another secure virtual network connection.

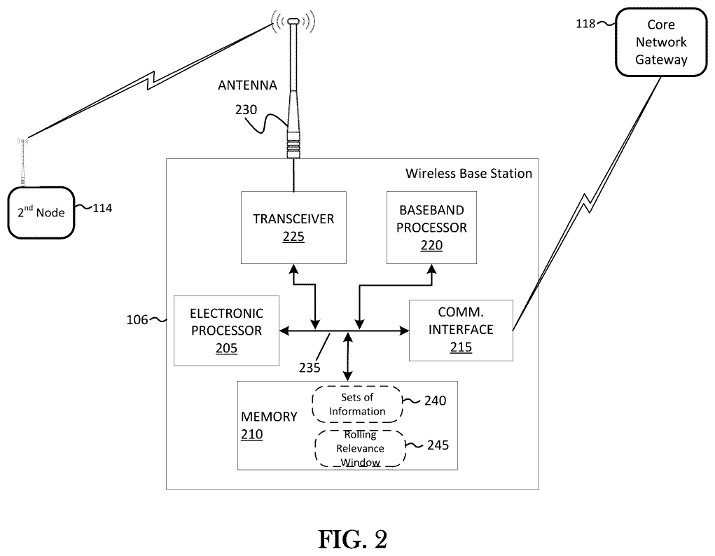

The first base station 106, the second base station 108, and the third base station 110, described more particularly with respect to FIG. 2, are wireless base stations for operating the field area network 102 to provide wireless communications to, from, and between the first end node 112, the second end node 114, and the third end node 116. In some instances, a base station of the field area network 102 may be referred to herein or in the accompanying figures as a “field network gateway” or an “FNG.”

The system 100 may include more components than those illustrated. In particular, it should be understood that, although FIG. 1 illustrates only three base stations and three end nodes, the system 100 may include a field area network servicing tens, hundreds, or even thousands of end nodes with hundreds of base stations.

In one example, the field area network 102 is a wireless network operating in the 450-470 MHz band using 12.5 kHz channels to provide narrowband packet-based data communications between 5 and 10 kbps. In one example, each of the base stations in the field area network 102 is configured to transmit data to the end nodes on a single downlink channel and receive data from the end nodes on one of many uplink channels, where the uplink and downlink frequencies are the same for each base station. Likewise, each of the end nodes is configured to receive data using the same downlink channel and transmit data on the same uplink channels. In some instances, the field area network 102 operates in geographic proximity to other users using the same or adjacent frequencies allocated from the same band as the field area network downlink and uplink channels.

As illustrated in FIG. 1, an end node may be able transmit signals that can be received by multiple base stations and, likewise, be able to receive signals transmitted from multiple base stations. For example, the first end node 112 is able to communicate with all three base stations, whereas the second end node 114 is only able to communicate with the first base station 106, and the third end node 116 is able to communicate with the first base station 106 and the third base station 110, but not the second base station 108. In some instances, an end node may be able to receive transmissions from a particular base station but may be unable to send transmissions receivable by that base station. In some instances, an end node may be able to send transmissions receivable by a particular base station but be unable to receive transmissions from that base station.

As an example, FIG. 1 is illustrated with the second end node 114 in communication with the first base station 106. As illustrated in FIG. 1, and described herein, the first base station 106 sends network information broadcasts to the end nodes (including the second end node 114) based on relevancy periods for the information and rolling relevance windows, as described herein, and the second end node 114 sends uplink data to the first base station 106.

In some embodiments, scheduling transmissions requires that base stations and end nodes are time synchronized. In such embodiments, the base stations are configured to maintain network timing by periodically transmitting a timing beacon, which is used by the end nodes to synchronize their uplink data transmissions.

FIG. 2 schematically illustrates one example embodiment of the first base station 106. In the embodiment illustrated, the base station 106 includes an electronic processor 205, a memory 210, a communication interface 215, a baseband processor 220, a transceiver 225, and an antenna 230. The illustrated components, along with other various modules and components are coupled to each other by or through one or more control or data buses (for example, the bus 235) that enable communication therebetween.

The electronic processor 205 may include one or more microprocessors, an application-specific integrated circuit (ASIC), or another suitable electronic device. The electronic processor 205 obtains and provides information (e.g., to and from the memory 210 and/or the communication interface 215) and processes the information by executing one or more software instructions or modules, capable of being stored, for example, in a random access memory (“RAM”) area of the memory 210, a read only memory (“ROM”) of the memory 210, or another non-transitory computer readable medium (not shown). The software can include firmware, one or more applications, program data, filters, rules, one or more program modules, and other executable instructions. In the embodiment illustrated, the memory 210 stores, among other things, sets of information 240 and a rolling relevance window 245 (both described in detail herein).

The electronic processor 205 is configured to retrieve from the memory 210 and execute, among other things, software related to the control processes and methods described herein. The electronic processor 205 executes instructions stored in the memory 210 to implement functionality of the first field network gateway 118.

The electronic processor 205 is configured to control the baseband processor 220 and the transceiver 225 to transmit and receive radiofrequency signals to and from the second end node 114 (and/or other end nodes) using the antenna 230. It should be noted that many base stations and other communication devices typically employ multiple antennas in practice, to realize spatial diversity (e.g., MIMO). The electronic processor 205, the baseband processor 220, and the transceiver 225 may include various digital and analog components (for example, digital signal processors, high band filters, low band filters, and the like), which for brevity are not described herein and which may be implemented in hardware, software, or a combination of both. In some embodiments, the transceiver 225 is a combined transmitter-receiver component. In other embodiments the transceiver 225 includes or may be replaced by separate transmitter and receiver components.

The electronic processor 205 is configured to control the communication interface 215 (and, in some embodiments, the antenna 230, another antenna (not shown), or a suitable wired connection) to transmit and receive communication signals to and from the core network gateway 118.

The description of base station 106 is provided as a representative example of other base stations deployed in the network, including base stations 108 and 110. In some aspects, one or more of the end nodes and the core network gateway 118, although they may not have identical functions and capabilities, include systems or devices having a similar general component configuration as the base station 106, in that they each include a respective electronic processor, memory, communication interface, input/output interface, and/or radiofrequency communication components coupled by at least one communication bus.

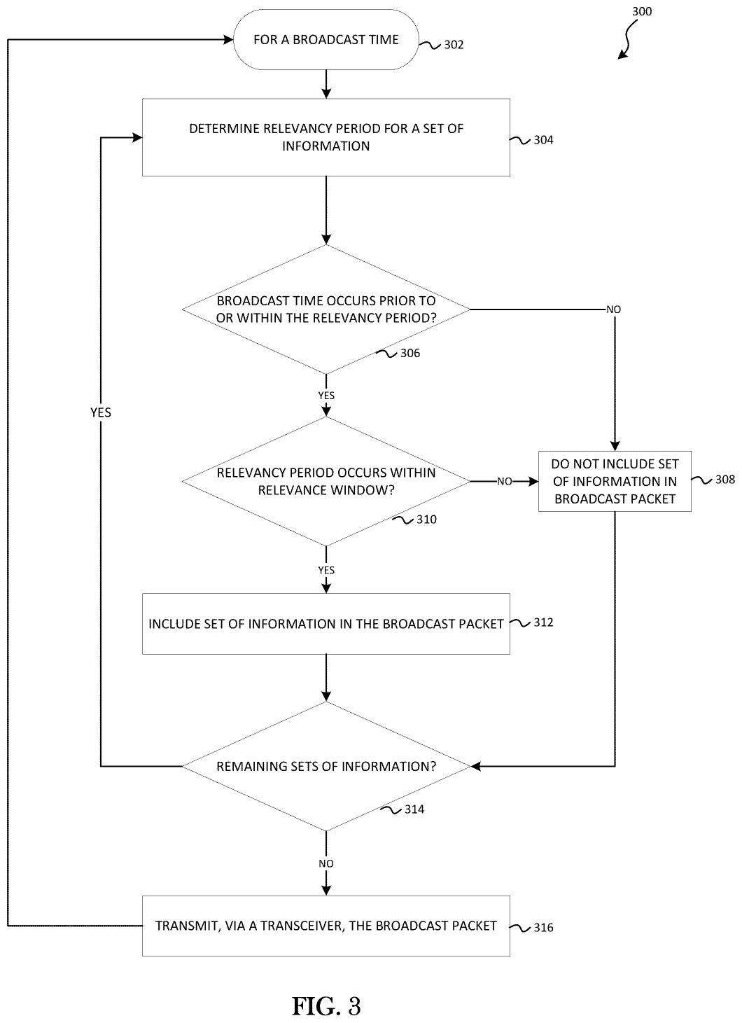

As noted, there is a need for improving packet reliability in wireless networks without introducing excessive overhead. Accordingly, FIG. 3 illustrates an example method 300 for, among other things, providing increased broadcast packet efficiency and information content reliability in a wireless communications system through the use of relevancy periods for the information content and rolling relevance windows. Although the method 300 is described in conjunction with the system 100 as described herein, the method 300 may be used with other systems and devices. In addition, the method 300 may be modified or performed differently than the specific example provided.

By way of example, the method 300 is described as being performed by the first base station 106 and, in particular, the electronic processor 205. However, it should be understood that, in some embodiments, portions of the method 300 may be performed by other devices, including for example, the core network gateway 118, one or more of the end nodes, of combinations of the foregoing. Additional electronic processors may also be included in the first base station 106 or other control equipment for the field area network 102 (not shown) that perform all or a portion of the method 300. For ease of description, the method 300 is described partially in terms of a single base station and a single end node. However, the method 300 may be applied to systems including multiple base stations and end nodes.

The method 300 is described in terms of broadcasting sets of information from a base station (e.g., the first base station 106) to one or more end nodes of a wireless network (e.g., the field area network 102). Each set of information (Qi) is relevant to the end nodes during a particular time period (Ti), known as the relevancy period. Prior to Ti, a device will benefit from knowing Qi. After Ti, there is no benefit to a device knowing Qi. In one example, a set of information Qi contains resources that an end node needs to configure itself to participate in the network.

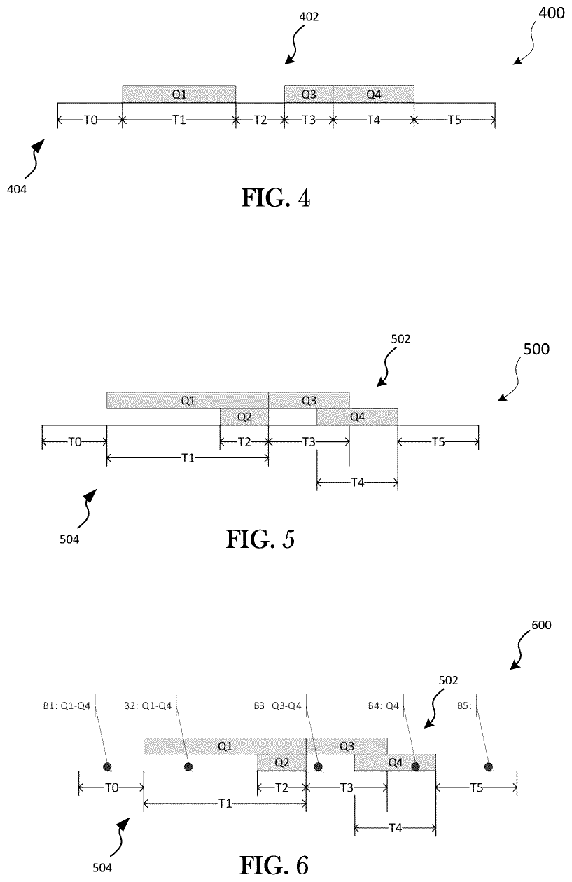

FIG. 4 illustrates a diagram 400, which illustrates three sets of information (402), Q1, Q3, and Q4 and six time periods (404) T0-T5. As illustrated in FIG. 4, Q1 is relevant during T1, Q3 is relevant during T3, and Q4 is relevant during T4. Periods T0, T2, and T5 do not have any corresponding information that is relevant.

In some aspects, relevancy periods may overlap. FIG. 5 illustrates a diagram 500, which illustrates four sets of information (502), Q1-Q4 and six time periods (504) T0-T5. As illustrated in FIG. 5, Q1 is relevant during T1, Q2 is relevant during T2, Q3 is relevant during T3, and Q4 is relevant during T4. Relevancy period T1 overlaps with but ends at the same time as T2. Relevancy period T3 overlaps T4 but ends during T4.

In this example, if a network coordinator device (e.g., a base station or field network gateway) needed to share the information in Q1, Q2, Q3, and Q4, it could broadcast four separate packets and repeat those packets such that sufficient packet reliability is achieved for each. However, depending on the transmission opportunities, some of that information may be irrelevant by the time an additional packet attempt is possible. Returning to FIG. 3, the method 300, as described below, groups the information sets (Qi) into a single broadcast, Bk, where each Bk contains only the relevant information (See FIG. 6).

The method 300 begins, at block 302, with the electronic processor 205 having a broadcast time and a plurality of sets of information to be broadcast. A broadcast time is a scheduled time for transmitting a broadcast packet. The broadcast time is determined based on network timing, conditions, and protocols.

Using the method 300, the electronic processor 205 determines which, if any, of the sets of information will be broadcast at the broadcast time. At block 304, the electronic processor 205 determines a relevancy period for a set of information. For example, the sets of information may be stored in a memory of the base station along with associated relevancy periods. In some aspects, relevancy periods are tied to actual time periods. In other aspects, relevancy periods are relative to one another based on the type of information contained in the sets of information. In some aspects, the relevancy periods are determined based on network protocol characteristics.

In some embodiments, the base station receives the sets of information (and associated relevancy periods) from the network core or another network device. In some embodiments, the base station derives relevancy periods based on the type of information contained in the sets of information according to pre-determined rules. In some embodiments, relevancy periods may be determined based on network conditions, as measured by, or reported to the base station.

At block 306, the electronic processor 205 determines whether the broadcast time occurs prior to or during the relevancy period. When the electronic processor 205 determines that first broadcast time does not occur prior to or during the relevancy period, it does not include the set of information in a broadcast packet to be transmitted at the broadcast time (at block 308). In some embodiments, when the electronic processor 205 determines that first broadcast time occurs prior to or during the relevancy period, it includes the set of information in a broadcast packet to be transmitted at the broadcast time. For example, FIG. 6 illustrates a diagram 600, which illustrates the four sets of information (502) and six time periods (504). FIG. 6 also illustrates five broadcast times B1-B5. The broadcast packet for each Bk contains only the relevant Qi. For example, B1 contains Q1 through Q4 because B1 occurs prior to the relevancy periods T1-T4. Although the relevancy period T1 has already begun at broadcast time B2, it also contains Q1 through Q4 because Q1 is still relevant at the time of the broadcast. However, the broadcast packet for broadcast time B3, only includes Q3 and Q4 as the relevancy periods T1 and T2 for Q1 and Q2 have expired. The broadcast packet for B4 contains only Q4. A broadcast packet generated for B5 would have no information and therefore it would be unnecessary to transmit at that broadcast time.

Returning to FIG. 3, in some embodiments, rolling relevancy windows are used to further determine broadcast packet contents. At block 310, responsive to determining that the broadcast time occurs prior to or during the relevancy period, the electronic processor 205 determines whether the relevancy period occurs within a rolling relevance window.

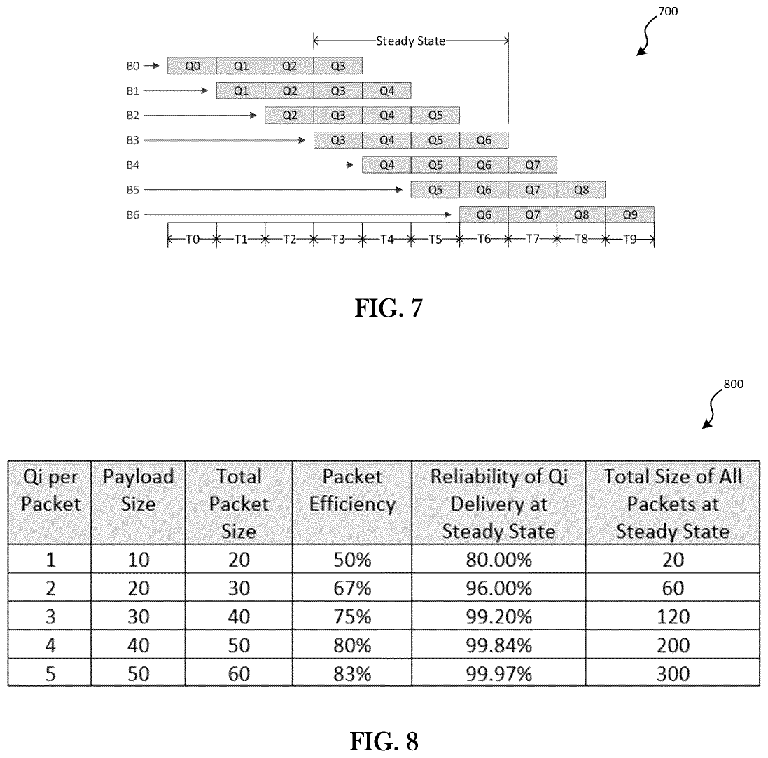

Using a rolling relevance window, the broadcasts can be aligned with the information sets and timed such that sufficient future information is provided in a redundant fashion to allow for receiving devices to miss some of the broadcasts but still be able to reconstitute the complete super set of information. For example, FIG. 7 illustrates a diagram 700 that shows seven broadcast packets, B0 through B6. Each contains a different collection of the information sets Q0-Q9. In the illustrated example, the relevancy periods T0-T9 are the same length, and the rolling relevance window has a duration of four relevancy periods.

As illustrated in FIG. 7, each successive broadcast occurs in time such that one information set is no longer relevant and need not be included in the broadcast packet. This frees up space in the packet to include the next information set. In the illustrated example, each broadcast contains four information sets in a rolling window of relevance. During the steady state period (which will continue in perpetuity as long as the broadcasts continue), a receiving device has as many opportunities to receive a given information set as the number of sets included in each broadcast packet. Thus, each broadcast packet always contains new information, excludes outdated information, and provides redundant information for those periods in the middle of its scope. This allows a receiver to, for example, miss any three of B0 through B3 and still receive Q3, and so on for each such Qi. It should be understood that it is not necessary to have strictly periodic broadcasts, nor adjacent periods of relevance.

There may be many Qi, which are relevant to receivers looking forward. However, as network bandwidth is limited, not all future Qi relevant to a receiver are able to be transmitted during a relevance window. Accordingly, in some aspects, the duration for the rolling relevance window can be based on a desired number of sets of information per packet. The desired number of sets N of information per packet can be generated based on one or more of an average single packet reliability and a radiofrequency environment responsiveness. For example, where N increases, reliability of transmissions from the base station will increase, but responsiveness decreases. Similarly, reducing N will increase responsiveness, but result in lowering reliability. In some embodiments, the value for N is set by the network core and dictated to base stations. In some embodiments, the base station is capable of modifying N, for example, based on measured or reported network conditions. In some embodiments, the desired reliability, and thus the value for N, is determined based on the network application.

Returning to FIG. 3, when the electronic processor 205 determines that the relevancy period occurs within the rolling relevance window, it includes the set of information in the broadcast packet (at 312).

Where there are no remaining sets of information to evaluate, the electronic processor 205 transmits the broadcast packet (at block 316). Where there are remaining sets of information to evaluate, the electronic processor 205 iterates the process (at blocks 304-314).

As illustrated in FIG. 3, in some aspects, the electronic processor 205 iterates for succeeding broadcast times. For example, for a succeeding broadcast time, the electronic processor 205 may generate a modified broadcast packet based on the current broadcast packet and the succeeding broadcast time. In some aspects, the electronic processor 205 generates the modified broadcast packet by removing a set of information from the broadcast packet when the relevancy period for that set of information expires prior to the succeeding broadcast time or falls outside the rolling relevance window. In some aspects, the electronic processor 205 generates the modified broadcast packet by adding one or more sets of information to the broadcast packet based on the relevancy periods for the new sets of information or the movement of the rolling relevance window, as described above with respect to FIG. 7.

FIG. 8 illustrates a table 800, which shows an example performance improvement achieved operating a network according to the embodiments described herein. Each row of the table 800 has an increasing number of Qi (sets of information) represented in the broadcast packet ranging 1 through 5. In this example, it is assumed that the size of each Qi in bytes is 10 and that the broadcast packet overhead is also 10 bytes. This allows us to measure the efficiency of each packet. As illustrated in FIG. 8, as more information is included, the efficiency goes up because the overhead is fixed. The steady state period for each of these packet types also ranges 1 to 5 as described herein, providing the repetition needed to increase the reliability of a single Qi. Assuming a single attempt packet reliability of 80%, as the steady state time increases there are more repetitions of each Qi driving the reliability up to 99.97% for a steady state relevancy window length of 5. As the number of Qi per packet increases, so does the steady state relevancy window length, as well as the total number of bytes transmitted across all packets in the relevancy window. This overall byte count is the measure of required bandwidth to achieve the information reliability.

Consider now the alternative of simply sending each Qi in its own packet multiple times to achieve the same reliability. As an example, if we desire to send Q1 through Q5 at a reliability of 99.97%, we will need to transmit each packet 5 times. Each Qi requires its own packet, so every packet is 50% efficient and we need to send each 5 times for a total of 25 total packets at 20 bytes each. This yields a cost of 500 bytes to achieve the same reliability for each of the Qi. In this scenario, the embodiments described herein yield a 40% cost reduction to achieve the same performance.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

In the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make any one or more than one of the multiple determinations.

Moreover, an embodiment can be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The following paragraphs provide various examples of the embodiments disclosed herein.

Example 1 is a wireless base station. The wireless base station comprises an electronic processor and a transceiver coupled to the electronic processor. The electronic processor is configured to, for each of a plurality of sets of information, determine a relevancy period. The electronic processor is configured to, for a first broadcast time, generate a broadcast packet that includes sets of information selected from the plurality of sets of information based on the relevancy periods. The electronic processor is configured to transmit, via the transceiver, the broadcast packet.

Example 2 may include the subject matter of Example 1 and may further specify that the electronic processor is configured to generate the broadcast packet by, for each set of information of the plurality of sets of information, determining whether the first broadcast time occurs prior to or during the relevancy period. The electronic processor is further configured to, when the first broadcast time occurs prior to or during the relevancy period, include the set of information in the broadcast packet.

Example 3 may include the subject matter of any of Examples 1 and 2 and may further specify that the electronic processor further configured to generate a modified broadcast packet based on the broadcast packet and a second broadcast time. The electronic processor is further configured to transmit, via the transceiver, the broadcast packet.

Example 4 may include the subject matter of Example 3 and may further specify that the electronic processor is configured to generate the modified broadcast packet by, for each set of information of the plurality of sets of information included in the broadcast packet, determining whether the relevancy period expires prior to the second broadcast time. The electronic processor is further configured to, when the relevancy period expires prior to the second broadcast time, removing the set of information from the broadcast packet.

Example 5 may include the subject matter of any of Examples 1 through 4 and may further specify that the electronic processor further configured to, for the first broadcast time, generate the broadcast packet that includes sets of information selected from the plurality of sets of information based on the relevancy periods and a rolling relevance window.

Example 6 may include the subject matter of Example 5 and may further specify that the electronic processor is configured to generate the broadcast packet by, for each set of information of the plurality of sets of information, determining whether the first broadcast time occurs prior to or during the relevancy period. The electronic processor is configured to, responsive to determining that the first broadcast time occurs prior to or during the relevancy period, determine whether the relevancy period occurs within the rolling relevance window. The electronic processor is configured to, when the relevancy period occurs within the rolling relevance window, include the set of information in the broadcast packet.

Example 7 may include the subject matter of Example 6 and may further specify that the electronic processor is configured to generate an adjusted rolling relevance window based on a second broadcast time. The electronic processor is configured to, for each set of information of the plurality of sets of information included in the broadcast packet, determine whether the relevancy period occurs within the adjusted rolling relevance window. The electronic processor is configured to, when the relevancy period does not occur within the rolling relevance window, generate a modified broadcast packet by removing the set of information from the broadcast packet. The electronic processor is configured to transmit, via the transceiver, the modified broadcast packet.

Example 8 may include the subject matter of Example 7 and may further specify that the electronic processor is configured to, for each set of information of the plurality of sets of information, determine whether the second broadcast time occurs prior to or during the relevancy period. The electronic processor is configured to, responsive to determining that the second broadcast time occurs prior to or during the relevancy period, determine whether the relevancy period occurs within the adjusted rolling relevance window. The electronic processor is configured to, when the relevancy period occurs within the adjusted rolling relevance window, generate the modified broadcast packet by adding the set of information in the broadcast packet.

Example 9 may include the subject matter of any of Examples 5 through 8, and may further specify that a duration for the rolling relevance window is based on a desired number of sets of information per broadcast packet.

Example 10 may include the subject matter of any of Examples 1 through 9, and may further specify that the desired number of sets of information per broadcast packet is generated based on one or more of an average single packet reliability and a radiofrequency environment responsiveness.

Example 11 is a method for operating a wireless base station. The method comprises determining, with an electronic processor, a relevancy period for each set of information of a plurality of sets of information. The method comprises, for a first broadcast time, generating a broadcast packet that includes sets of information selected from the plurality of sets of information based on the relevancy periods. The method comprises, transmitting, via a transceiver, the broadcast packet.

Example 12 may include the subject matter of Example 11 and may further include, for each set of information of the plurality of sets of information, determining whether the first broadcast time occurs prior to or during the relevancy period. Example 12 may further include, when the first broadcast time occurs prior to or during the relevancy period, including the set of information in the broadcast packet.

Example 13 may include the subject matter of any of Examples 11 and 12 and may further include generating a modified broadcast packet based on the broadcast packet and a second broadcast time. Example 13 may further include transmitting, via the transceiver, the broadcast packet.

Example 14 may include the subject matter of Example 13 and may further include, for each set of information of the plurality of sets of information included in the broadcast packet, determining whether the relevancy period expires prior to the second broadcast time. Example 13 may further include, when relevancy period expires prior to the second broadcast time, removing the set of information from the broadcast packet to generate the modified broadcast packet.

Example 15 may include the subject matter of any of Examples 11 through 14 and may further include generating the broadcast packet based on the relevancy periods and a rolling relevance window.

Example 16 may include the subject matter of Example 15 and may further include, for each set of information of the plurality of sets of information, determining whether the first broadcast time occurs prior to or during the relevancy period. Example 16 may further include, responsive to determining that the first broadcast time occurs prior to or during the relevancy period, determining whether the relevancy period occurs within the rolling relevance window. Example 16 may further include, when the relevancy period occurs within the rolling relevance window, including the set of information in the broadcast packet.

Example 17 may include the subject matter of Example 16 and may further include generating an adjusted rolling relevance window based on a second broadcast time. Example 17 may further include, for each set of information of the plurality of sets of information included in the broadcast packet, determining whether the relevancy period occurs within the adjusted rolling relevance window. Example 17 may further include, when the relevancy period does not occur within the rolling relevance window, generating a modified broadcast packet by removing the set of information from the broadcast packet. Example 17 may further include transmitting, via the transceiver, the modified broadcast packet.

Example 18 may include the subject matter of Example 17 and may further include, for each set of information of the plurality of sets of information, determining whether the second broadcast time occurs prior to or during the relevancy period. Example 18 may further include, responsive to determining that the second broadcast time occurs prior to or during the relevancy period, determining whether the relevancy period occurs within the adjusted rolling relevance window. Example 18 may further include, when the relevancy period occurs within the adjusted rolling relevance window, generating the modified broadcast packet by adding the set of information in the broadcast packet.

Example 19 may include the subject matter of Example 15 and may further include determining a duration for the rolling relevance window based on a desired number of sets of information per packet.

Example 20 may include the subject matter of claim 18, and may further specify that the desired number of sets of information per packet is generated based on one or more of an average single packet reliability and a radiofrequency environment responsiveness.

Example 21 may include one or more non-transitory computer readable media having instructions thereon that, when executed by one or more electronic processors, cause the one or more electronic processors to perform the subject matter of any one or more of Examples 11 through 20.

We claim:

1. A wireless base station comprising:
an electronic processor; and
a transceiver coupled to the electronic processor;
wherein the electronic processor is configured to:
for each of a plurality of sets of information, determine a relevancy period;
for a first broadcast time, generate a broadcast packet that includes sets of information selected from the plurality of sets of information based on the relevancy periods; and
transmit, via the transceiver, the broadcast packet.

2. The wireless base station of claim 1, wherein the electronic processor is further configured to generate the broadcast packet by:
for each set of information of the plurality of sets of information:
determining whether the first broadcast time occurs prior to or during the relevancy period; and
when the first broadcast time occurs prior to or during the relevancy period, including the set of information in the broadcast packet.

3. The wireless base station of claim 1, wherein the electronic processor is further configured to:
generate a modified broadcast packet based on the broadcast packet and a second broadcast time; and
transmit, via the transceiver, the broadcast packet.

4. The wireless base station of claim 3, wherein the electronic processor is further configured to generate the modified broadcast packet by:
for each set of information of the plurality of sets of information included in the broadcast packet:
determining whether the relevancy period expires prior to the second broadcast time; and
when the relevancy period expires prior to the second broadcast time, removing the set of information from the broadcast packet.

5. The wireless base station of claim 1, wherein the electronic processor is further configured to:
for the first broadcast time, generate the broadcast packet that includes sets of information selected from the plurality of sets of information based on the relevancy periods and a rolling relevance window.

6. The wireless base station of claim 5, wherein the electronic processor is further configured to generate the broadcast packet by:
for each set of information of the plurality of sets of information:
determining whether the first broadcast time occurs prior to or during the relevancy period;
responsive to determining that the first broadcast time occurs prior to or during the relevancy period, determining whether the relevancy period occurs within the rolling relevance window; and
when the relevancy period occurs within the rolling relevance window, including the set of information in the broadcast packet.

7. The wireless base station of claim 6, wherein the electronic processor is further configured to:
generate an adjusted rolling relevance window based on a second broadcast time;
for each set of information of the plurality of sets of information included in the broadcast packet:
determine whether the relevancy period occurs within the adjusted rolling relevance window, and
when the relevancy period does not occur within the rolling relevance window, generate a modified broadcast packet by removing the set of information from the broadcast packet; and
transmit, via the transceiver, the modified broadcast packet.

8. The wireless base station of claim 7, wherein the electronic processor is further configured to:
for each set of information of the plurality of sets of information:
determine whether the second broadcast time occurs prior to or during the relevancy period;
responsive to determining that the second broadcast time occurs prior to or during the relevancy period, determine whether the relevancy period occurs within the adjusted rolling relevance window; and
when the relevancy period occurs within the adjusted rolling relevance window, generate the modified broadcast packet by adding the set of information in the broadcast packet.

9. The wireless base station of claim 5, wherein a duration for the rolling relevance window is based on a desired number of sets of information per broadcast packet.

10. The wireless base station of claim 9. wherein the desired number of sets of information per broadcast packet is generated based on one or more of an average single packet reliability and a radiofrequency environment responsiveness.

11. A method for operating a wireless base station, the method comprising:
determining, with an electronic processor, a relevancy period for each set of information of a plurality of sets of information;
for a first broadcast time, generating a broadcast packet that includes sets of information selected from the plurality of sets of information based on the relevancy periods; and
transmitting, via a transceiver, the broadcast packet.

12. The method of claim 11, wherein generating the broadcast packet includes:
for each set of information of the plurality of sets of information:
determining whether the first broadcast time occurs prior to or during the relevancy period; and
when the first broadcast time occurs prior to or during the relevancy period, including the set of information in the broadcast packet.

13. The method of claim 11, further comprising:
generating a modified broadcast packet based on the broadcast packet and a second broadcast time; and
transmitting, via the transceiver, the broadcast packet.

14. The method of claim 13, wherein generating the modified broadcast packet includes:
for each set of information of the plurality of sets of information included in the broadcast packet:
determining whether the relevancy period expires prior to the second broadcast time; and
when the relevancy period expires prior to the second broadcast time, removing the set of information from the broadcast packet.

15. The method of claim 11, wherein generating the broadcast packet that includes sets of information selected from the plurality of sets of information includes generating the broadcast packet based on the relevancy periods and a rolling relevance window.

16. The method of claim 15, wherein generating the broadcast packet includes:
for each set of information of the plurality of sets of information:
determining whether the first broadcast time occurs prior to or during the relevancy period;
responsive to determining that the first broadcast time occurs prior to or during the relevancy period, determining whether the relevancy period occurs within the rolling relevance window; and
when the relevancy period occurs within the rolling relevance window, including the set of information in the broadcast packet.

17. The methods of claim 16, further comprising:
generating an adjusted rolling relevance window based on a second broadcast time;
for each set of information of the plurality of sets of information included in the broadcast packet:
determining whether the relevancy period occurs within the adjusted rolling relevance window, and
when the relevancy period does not occur within the rolling relevance window, generating a modified broadcast packet by removing the set of information from the broadcast packet; and
transmitting, via the transceiver, the modified broadcast packet.

18. The method of claim 17, further comprising:
for each set of information of the plurality of sets of information:
determining whether the second broadcast time occurs prior to or during the relevancy period;
responsive to determining that the second broadcast time occurs prior to or during the relevancy period, determining whether the relevancy period occurs within the adjusted rolling relevance window; and
when the relevancy period occurs within the adjusted rolling relevance window, generating the modified broadcast packet by adding the set of information in the broadcast packet.

19. The method of claim 15, further comprising:
determining a duration for the rolling relevance window based on a desired number of sets of information per broadcast packet.

20. The method of claim 19, wherein the desired number of sets of information per broadcast packet is generated based on one or more of an average single packet reliability and a radiofrequency environment responsiveness.
